(19) United States
(12) Patent Application Publication
(10) Pub. No.: US 2025/0191398 A1
(43) Pub. Date: Jun. 12, 2025

(54) CHARACTER PROCESSING METHOD AND APPARATUS, AND ELECTRONIC DEVICE AND STORAGE MEDIUM

(71) Applicant: Beijing Zitiao Network Technology Co., Ltd., Beijing (CN)

(72) Inventors: Wei LIU, Beijing (CN); Fangyue LIU, Beijing (CN)

(21) Appl. No.: 18/856,038

(22) PCT Filed: Apr. 18, 2023
(86) PCT No.: PCT/CN2023/088820

§ 371 Date: Oct. 10, 2024

(30) Foreign Application Priority Data
Apr. 18, 2022 (CN) 202210405578.X

(51) Int. Cl. G06V 30/32; G06V 10/82; G06V 30/19

(52) U.S. Cl. CPC G06V 30/347; G06V 30/19147; G06V 30/1918; G06V 10/82

(57) ABSTRACT

A character processing method and apparatus, an electronic device and a storage medium. The method includes: acquiring a first image comprising a to-be-processed character; training a target stroke order determination model by combining with a spatial attention mechanism and a channel attention mechanism; and inputting the first image into the target stroke order determination model trained in advance to obtain a target stroke order corresponding to the to-be-processed character.

This application claims priority to Chinese Patent Application No. 202210405578. X, filed with the CNIPA on Apr. 18, 2022, the disclosure of which is incorporated herein in its entirety by reference.

### TECHNICAL FIELD

Embodiments of the present disclosure relate to the technical field of artificial intelligence, for example, to a character processing method and apparatus, an electronic device and a storage medium.

### BACKGROUND

Currently, researches related to generation of fonts by using artificial intelligence (AI) have been gradually expanded, which not only satisfies the demands of users for multiple types of fonts but also improves the production efficiency of designers.

In the actual generation of characters by using correlation model, the style transfer or picture translation technology in the related art excels at correcting the texture of the picture, but does not excel at correcting the structural information of the picture. However, in the field of character generation, the character form is just an important distinction between fonts. Therefore, there are often many problems in the fonts obtained based on the related art, such as broken strokes, uneven stroke edges, missing or redundant strokes, etc., which not only results in a difference between the automatically generated characters and the characters desired by the user, but also involves higher error rate.

### SUMMARY

The present disclosure provides a character processing method and apparatus, an electronic device and a storage medium, which can accurately obtain positions and orders of various strokes in the characters, greatly reduces the occurrence of stroke breakage, stroke edge irregularity, stroke loss or stroke redundancy in the generated characters, and improves the accuracy of the generated characters.

In a first aspect, an embodiment of the present disclosure provides a character processing method, including:
acquiring a first image including a to-be-processed character;
training a target stroke order determination model by combining with a spatial attention mechanism and a channel attention mechanism;
inputting the first image into the target stroke order determination model trained in advance to obtain a target stroke order corresponding to the to-be-processed character.

In a second aspect, an embodiment of the present disclosure further provides a character processing apparatus, including:
a first image acquisition module, configured to acquire a first image including a to-be-processed character;
a stroke order determination model training module, configured to train a target stroke order determination model by combining with a spatial attention mechanism and a channel attention mechanism; and
a target stroke order determination module, configured to input the first image into the target stroke order determination model trained in advance to obtain a target stroke order corresponding to the to-be-processed character.

In a third aspect, an embodiment of the present disclosure further provides an electronic device, including:
at least one processor; and
a storage device configured to store at least one program,
the at least one program, when executed by the at least one processor, is configured to cause the
at least one processor to implement the character processing method according to any one of the embodiments of the present disclosure.

In a fourth aspect, an embodiment of the present disclosure further provides a storage medium containing computer-executable instructions, wherein the computer-executable instructions, when executed by a computer processor, are configured to implement the character processing method according to any one of the embodiments of the present disclosure.

### BRIEF DESCRIPTION OF DRAWINGS

Throughout the drawings, the same or similar reference numerals refer to the same or similar elements. It should be understood that the figures are schematic and that components and elements are not necessarily drawn to scale.

FIG. 1 is a flowchart illustrating a character processing method according to an embodiment of the present disclosure;

FIG. 2 is a schematic diagram of a stroke order determination model according to an embodiment of the present disclosure;

FIG. 3 is a flowchart illustrating another character processing method according to an embodiment of the present disclosure;

FIG. 4 is a schematic diagram of a style feature fusion model according to an embodiment of the present disclosure;

FIG. 5 is a schematic diagram of a target character style according to an embodiment of the present disclosure;

FIG. 6 is a schematic structural diagram of a character processing apparatus according to an embodiment of the present disclosure; and

FIG. 7 is a schematic structural diagram of an electronic device according to an embodiment of the present disclosure.

### DETAILED DESCRIPTION

Embodiments of the present disclosure will be described in more details below with reference to the accompanying drawings.

It should be understood that the various steps recited in the method implementation of the present disclosure may be executed in a different order, and/or in parallel. Further, the method implementation may include additional steps and/or omit performing illustrated steps. The scope of the present disclosure is not limited in this regard.

As used herein, the term “comprise/include” and its variations are open-ended inclusion, i.e., “comprising/including but not limited to”. The term “based on” refers to “based at least in part on”. The term “an embodiment” refers to “at least one embodiment”; the term “another embodiment” refers to “at least one additional embodiment”; and the term “some embodiments” refers to “at least some embodiments”. Definitions of other terms will be given in the description below.

It is to be noted that concepts such as “first” and “second” mentioned in this disclosure are only used to distinguish different devices, modules, or units, and are not used to limit the order of functions performed by these devices, modules, or units, or interdependences thereof. It is to be noted that the modifications of “one” and “a plurality of” mentioned in this disclosure are illustrative and not restrictive. Those skilled in the art will be appreciated that it should be understood as “one or more” unless the context clearly indicates otherwise.

The names of messages or information exchanged between multiple devices in the embodiments of the present disclosure are for illustrative purposes only and are not used to limit the scope of these messages or information.

Before introducing the present technical solution, the application scenario may be exemplarily explained first. This technical solution can be applied to a scenario in which a stroke order of a character is determined with high accuracy based on a neural network. For example, when a character of a certain font is generated using an artificial intelligence correlation algorithm, there may be problems of broken strokes, uneven stroke edges, missing strokes or redundant strokes in the generated character. In such case, the stroke order of the character and the positions of various strokes can be accurately determined based on the solution of the present embodiment, thereby avoiding the above problems.

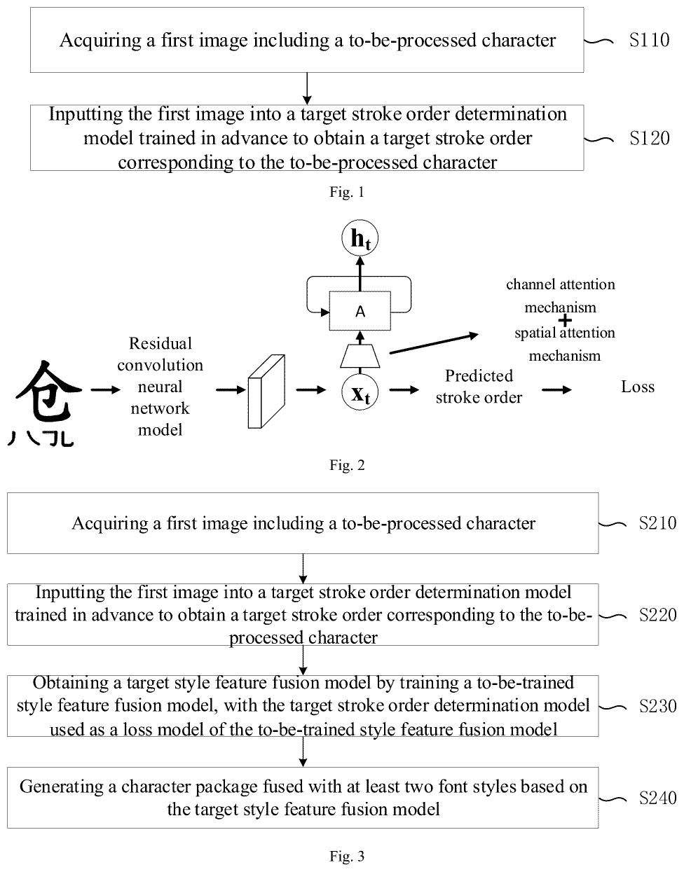

FIG. 1 is a flowchart illustrating a character processing method according to an embodiment of the present disclosure, which is suitable for determining the stroke order of character with high accuracy. The method may be performed by a character processing apparatus, which may be implemented in the form of software and/or hardware, optionally, by an electronic device. The electronic device may be a mobile terminal, a personal computer (PC) or a server.

As shown in FIG. 1, the method includes:

S110, acquiring a first image including a to-be-processed character.

The first image may be an image received by a server or a client and photographed by the user in real time through a photographing device, or may be a stored image retrieved by the server or the client from an associated database, and at least one or more characters are included in the image. It should be understood that the character in the image is the to-be-processed character, and at least the stroke order of the to-be-processed characters is determined based on the neural network model according to the embodiment of the present disclosure.

For example, when a user photographs a calligraphic work containing a Chinese character and uploads the photographed image to a server or client, the image is a first image, and the server or client may recognize the image based on a correlation algorithm to determine the Chinese character in the image as a to-be-processed character. Of course, in practical applications, the characters in the first image may be of types other than Chinese characters, such as English words or Latin words, etc., and the number of characters to be processed in the first image may be at least one, which is not limited in the embodiment of the present disclosure.

S120, inputting the first image into a target stroke order determination model trained in advance to obtain a target stroke order corresponding to the to-be-processed character.

In this embodiment, when the server or the client determines the first image, the image may be input into a target stroke order determination model having been trained in advance, wherein the target stroke order determination model may be a Long Short-Term Memory (LSTM) model with a spatial attention mechanism and a channel attention mechanism, that is, the model is trained in combination with the spatial attention mechanism and the channel attention mechanism.

In this embodiment, the target stroke order determination model is incorporated with a spatial attention mechanism as well as a channel attention mechanism. Exemplarily, based on the spatial attention mechanism, the model may transform the spatial information in the original image to another space by using a spatial transformer, and extract and preserve its key information during this process; based on the channel attention mechanism, the model may add a weight to the signal on each channel during the convolution process to indicate the degree of correlation of the channel with respect to the key information in the image. It will be appreciated that the larger the weight, the greater the degree of correlation of the channel with respect to the key information.

In this embodiment, after the first image is input into the target stroke order determination model for processing, the model outputs the target stroke order corresponding to the to-be-processed character. The target stroke order is information reflecting the form of the to-be-processed character, as well as the position and order of each stroke constituting the character. For example, when the to-be-processed character in the input first image is “ [symbol] ”, the model may output the positions and stroke orders of the four strokes of the character, and determine the form of the character at the same time.

It is to be noted that before applying the target stroke order determination model of the embodiment of the present disclosure, it needs to train a to-be-trained stroke order determination model firstly. Optionally, acquiring at least one first training sample; for the at least one first training sample, inputting a sample character image from a current first training sample into a to-be-trained stroke order determination model to obtain a predicted stroke order; determining a loss value based on the predicted stroke order and a theoretical character stroke order in the current first training sample, and correcting a parameter of the to-be-trained stroke order determination model based on the loss value; taking a convergence of a loss function in the to-be-trained stroke order determination model as a training target, and obtaining the target stroke order determination model.

The first training sample includes a sample character image and a theoretical character stroke order corresponding to the sample character image. For example, the sample character image may be an image corresponding to the Chinese character “ [symbol] ”, and the theoretical character stroke order is information that accurately characterizes the position and order of each stroke of the character “ [symbol] ”. Based on this information, the server or the client may accurately determine a standard character “ [symbol] ”.

In this embodiment, when the first training sample is obtained, each of the samples therein is input into the to-be-trained stroke order determination model, thereby acquiring a predicted stroke order. Continuing with the above example, the to-be-trained stroke order determination model outputs information characterizing the position and order of each stroke of the Chinese character “ [symbol] ” after processing the image corresponding to the Chinese character “ [symbol] ”. However, in the case where the training of the model is not completed, the server and the client cannot accurately construct the Chinese character based on the predicted stroke order corresponding to the character “ [symbol] ”, and the generated “ [symbol] ” may have a problem of partial stroke error, for example, a character “ [symbol] ” may be generated based on the predicted stroke order.

Therefore, after acquiring the predicted stroke order of the training sample, it is also necessary to determine a loss value of the model based on the predicted stroke order and the theoretical character stroke order in the training sample, thereby correcting the model parameters. Exemplarily, when the model parameters in the to-be-trained stroke order determination model are corrected by using the loss value, a convergence of a loss function may be taken as a training target, e.g., judging whether the training error is smaller than a preset error, or judging whether the error variation tends to be stable, or judging whether the current number of iterations is equal to a preset number. If it's detected that the convergence condition is reached, for example, the training error of the loss function is smaller than a preset error, or the error variation tends to be stable, it indicates that the training of the to-be-trained stroke order determination model is completed, the iterative training may be stopped at this time. If it is detected that the convergence condition is not currently reached, other training samples may be further acquired to continue training the to-be-trained stroke order determination model until the training error of the loss function is within a predetermined range. When the training error of the loss function reaches the convergence condition, the stroke order determination model having been well trained can be used as the target stroke order determination model, i.e., at this time, after inputting a character image into the target stroke order determination model, the stroke order of the character in the image can be accurately obtained.

It should be noted that both the target stroke order determination model and the to-be-trained stroke order determination model can process the character image in accordance with the following sequence. Optionally, inputting the sample character image into a convolutional layer to obtain a first to-be-processed feature; performing feature extraction on the first to-be-processed feature by means of a channel attention mechanism and a spatial attention mechanism to obtain a second to-be-processed feature; inputting the second to-be-processed feature into a recurrent neural network unit to obtain a feature sequence corresponding to the position and order of each stroke; processing the feature sequence based on a classifier to obtain a predicted stroke order. This process is described below in connection with FIG. 2.

It should be understood by those skilled in the art that the convolution layer is composed of several convolution units, and the parameters of each convolution unit can be optimized by a backpropagation algorithm. Referring to FIG. 2, taking the to-be-trained stroke order determination model as an example, after inputting a sample character image into the model, the image can be processed based on a Residual Network (ResNet) model, which can be understood as a sub-network, to extract a plurality of features corresponding to the character image. Also, when the convolution layer is at the first layer of the neural network, the extracted features may be some low-level features, i.e., the first to-be-processed feature.

With continued reference to FIG. 2, based on the channel attention mechanism and the spatial attention mechanism, a feature extraction can be performed on the first to-be-processed feature so as to obtain the second to-be-processed feature which is more advanced and abstract. Since the stroke order determination model includes a plurality of recurrent neural network units, after acquiring a plurality of second to-be-processed features, it's necessary to further input these features to the corresponding recurrent neural network units, thereby acquiring a feature sequence for the position and the order of each stroke. It should be understood that the feature sequence is just the output of each recurrent neural network unit.

With continued reference to FIG. 2, once the feature sequence is acquired, the feature sequence may be processed by a classifier to obtain a predicted stroke order for the character. The classifier in the model according to the embodiment of the present disclosure is a classification function learned based on existing data or a classification model constructed based on existing data, which function or model maps the data to a certain item in a given category, so as to predict the stroke order of the character. It will be appreciated that, a feature obtained by juxtaposing the feature vectors extracted from various recurrent neural network (RNN) units is a stroke order feature (SOF). For any network that generates characters, it can extract an SOF, i.e., SOF fake, from a fake image by the model; furthermore, it can also extract an SOF, i.e., SOF gt, from the labeled data (ground truth) corresponding to the fake image. Based on these data, an additional loss (e.g., focal loss) can be generated for the to-be-trained stroke order determination model, so as to improve the quality of the generated fonts.

Illustratively, the module A of FIG. 2 includes a plurality of recurrent neural network units, which may be represented by A1, A2, . . . , AN, and the number of these units may correspond to the maximum number of strokes for a certain type of character. For example, when the character is a Chinse character, the number of the recurrent neural network units may be 36. After inputting the second to-be-processed feature into A1, a corresponding output H1, i.e., the information characterizing the position and order of a first stroke of the Chinese character can be obtained; at the same time, A1 can also output a parameter distinguished from H1, and this parameter is input into A2, then A2 can output H2, i.e., the information characterizing the position and order of a second stroke of the Chinese character; at the same time, A2 outputs a parameter distinguished from H2, and this parameter is input into A3; and so on, thereby acquiring the information regarding the positions and orders of the individual strokes of the Chinese character in a stepwise manner. It can be understood that, in the above example, if the number of strokes of the Chinese character does not reach the number of the recurrent neural network units, after acquiring the information regarding the positions and orders of the individual strokes of the Chinese character, the output of the subsequent at least one recurrent neural network is zero, which will not be particularly described in the embodiments of the present disclosure.

It is to be noted that the technical solution according to the embodiments of the present disclosure can be applied to office software installed in the server or the client, that is, the above-mentioned target stroke order determination model is integrated in the office software. Based on this, upon receiving a character image input by a user, the office software deployed on the server or the client can accurately determine the information regarding the positions and orders of the strokes of the character in the image based on the target stroke order determination model, thereby performing subsequent processing according to actual requirements based on this information.

The technical solution according to the embodiments of the present disclosure includes: acquiring a first image including a to-be-processed character firstly, and then inputting the first image into a target stroke order determination model trained in advance including a spatial attention mechanism and a channel attention mechanism, thereby obtaining a target stroke order corresponding to the to-be-processed character. By introducing the above-mentioned two mechanisms into the stroke order determination model, the position and order of each stroke of the character can be accurately obtained, thereby greatly reducing the occurrence of stroke breakage, stroke edge irregularity, stroke loss or stroke redundancy in the generated character and improving the accuracy rate of the generated character.

FIG. 3 is a flowchart illustrating a character generating method according to an embodiment of the present disclosure. Based on the previous embodiment, the target stroke order determination model is used as a loss function of a to-be-trained style feature fusion model to obtain a target style feature fusion model through training, which allows a user to use the model to fuse a font style of a to-be-processed character and a font style of a reference character to obtain any one font style between the font style of the to-be-processed character and the font style of the reference character, and solves the problem that characters having a font style between two font styles cannot be generated; at the same time, the style feature fusion model constructed based on a plurality of sub-models solves the problem that the font style of the target character is not identical to the character style desired by the user. For the specific implementation thereof, reference can be made to the technical solution of this embodiment, in which the technical terms identical or corresponding to the above-described embodiments are not repeated herein.

As shown in FIG. 3, the method includes the following steps:

S210, acquiring a first image including a to-be-processed character.

S220, inputting the first image into a target stroke order determination model trained in advance to obtain a target stroke order corresponding to the to-be-processed character.

S230, obtaining a target style feature fusion model by training a to-be-trained style feature fusion model, with the target stroke order determination model used as a loss model of the to-be-trained style feature fusion model.

The target style feature fusion model is configured to fuse at least two font styles. It can be understood as a model of fusing different font styles. The target style feature fusion model may be a pre-trained neural network model having input data in an image format and output data in an image format. The target style feature can be understood as any one font style between the character style of the to-be-processed character and the character style of the reference character, which is obtained by performing fusion processing according to the two font styles. It should be noted that the fused style features may include a plurality of font styles, and any one of these font styles may be used as the target style feature; accordingly, the target character in the output image may be understood as a character having the target style feature.

In this embodiment, the input of the target style feature fusion model may be a to-be-processed character image and a reference character image, and the output image is an image corresponding to the character with target style feature. Exemplarily, the to-be-processed character may be understood as a character to which the user desires to perform a font style conversion; the character in the to-be-processed character image may be a character selected by the user from a font gallery, and may be a character written by the user. For example, after the user writes the character, the written character may be subjected to an image recognition, so that the recognized character may be used as the to-be-processed character. The character in the reference character image may be understood as a character of which the font style needs to be fused with the character style of the to-be-processed character, for example, the style of the reference character may include a regular script style, an official script style, a semi-cursive style, a cursive style, or a user's handwritten font style, or the like.

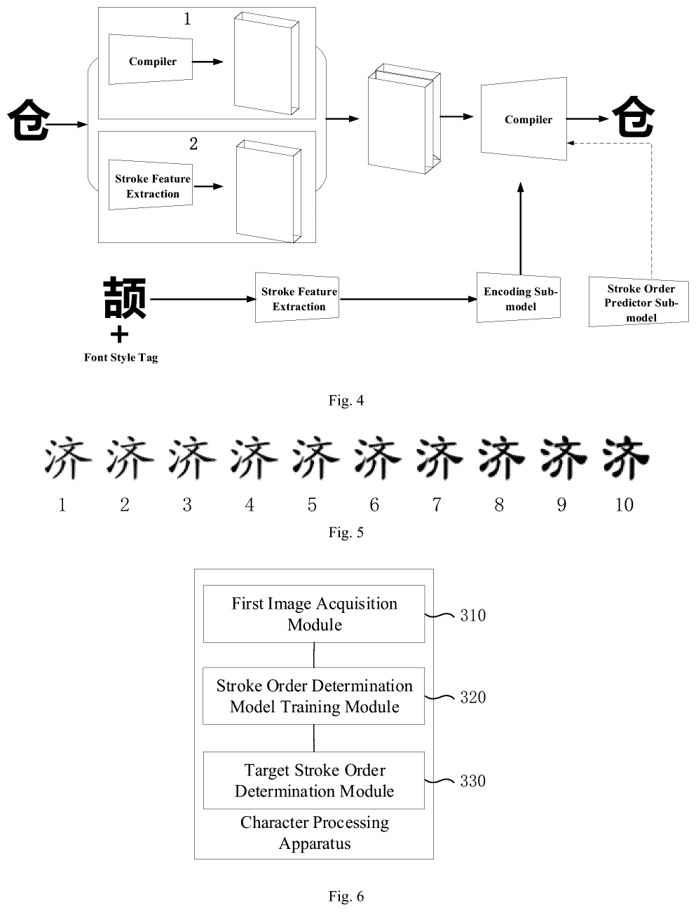

Exemplarily, after acquiring the to-be-processed character image and the reference character image, the to-be-processed character image and the reference character image may be input into a to-be-trained style feature fusion model. Referring to FIG. 4, the to-be-processed character in the to-be-processed character image is “ [symbol] ”, the reference character in the reference character image is “ [symbol] ”, and these two characters have different font styles. After the to-be-processed character and the reference character are input, the two characters are converted into corresponding two to-be-processed images by image conversion, and then the obtained two to-be-processed images are input into the to-be-trained style feature fusion model. After the two to-be-processed images are processed based on the to-be-trained style feature fusion model, font styles between the font style of the to-be-processed character and the font style of the reference character can be obtained, any one of these font styles is used as a target font style, and a target character corresponding to the target font style can be obtained.

It's to be noted that, if the target style feature of the obtained character does not match the style feature desired by the user, the user may take the character with the target font style as the to-be-processed character and continue to fuse the style features of fonts until a style feature satisfactory for the user is obtained.

Exemplarily, the case where a font style processing for “ [symbol] ” is described by way of example. Referring to FIG. 5, a to-be-processed character image numbered 1 and a to-be-processed character image numbered 10 are input into the target style feature fusion model to obtain any one of font styles numbered 2 to 9, and the any one font style may be taken as the target style feature. For example, if the target font style feature as obtained is the font style numbered 5 and the font style actually required by the user is the font style numbered 8, i.e., if the target font style feature as obtained is different from the font style feature desired by the user, a fusion processing of the font styles may be continued to perform based on the target style feature fusion model. Optionally, font styles numbered 5 and 10 are input, as to-be-processed character images, into the target style feature fusion model for processing until a target font style consistent with the user's desired font style is obtained.

In a process of training the target style feature fusion model, optionally, determining at least one second training sample; inputting, for the at least one second training sample, a to-be-trained character image and a reference character image of a current training sample into the to-be-trained style feature fusion model to obtain an actually output character image corresponding to the to-be-trained character image; performing stroke loss processing on the actually output character image and the to-be-trained character image based on the target stroke order determination model to obtain a first loss value; determining a reconstruction loss for the actually output character image and the to-be-trained character image based on a reconstruction loss function; and determining a style loss value for the actually output character image and a fused character image based on a style encoding loss function.

It can be understood that the to-be-trained character image and the reference character image are included in the training sample; the fused character image is determined based on font styles of the to-be-trained character image and the reference character image. For example, when an image of a to-be-trained character “ [symbol] ” and an image of a reference character “ [symbol] ” in a training sample are obtained, the images of the two characters may be input into the to-be-trained style feature fusion model, thereby obtaining an image of the character “ [symbol] ” with a font style similar to that of the character “ [symbol] ”, i.e., an actually output character image; at the same time, in the case where the training of the model has not been completed, the image may not accurately reflect the form of the strokes of the character “ [symbol] ”, e.g., the positions of the strokes of the generated character “ [symbol] ” are not accurate and even a character “ [symbol] ” may be generated, or the generated character “ [symbol] ” fails to accurately represent the font style of the character “ [symbol] ”. Therefore, it is necessary to further perform stroke loss processing on the image of the actually output character “ [symbol] ” and the image of the to-be-processed character “ [symbol] ” based on a target stroke order determination model (Stroke Order Loss) which has been well trained and integrated into the model to obtain the first loss value. It is to be understood that the number of the nodes of the RNN in the target stroke order determination model is the maximum number of the strokes of Chinese characters, and the predicted features at various nodes are combined together by a connection function to form a matrix of stroke order features, which may be performed in the manner described in details in the above embodiments, and will not be repeated herein.

In the present embodiment, if the actually output character image is an image of the character “ [symbol] ”, a reconstruction loss of the actually output image of the character “ [symbol] ” and the to-be-trained character image (i.e., the image of the standard character “ [symbol] ”) may be determined based on a reconstruction loss function (Rec Loss). It will be appreciated that the reconstruction loss function is used to visually constrain the network output to be in accordance with the reconstruction loss and to correct the model parameters in a subsequent process, so that the model with corrected parameters can output a character of which the positions and orders of strokes are exactly coincide with those of the character “ [symbol] ”.

In the present embodiment, if the actually output character image is an image of character “ [symbol] ” but has a considerably different font style from that of the character “ [symbol] ”, a style loss value of the actually output character “ [symbol] ” and a fused character image (i.e., an image having the same font style as the character “ [symbol] ”) may be determined based on a style encoding loss function (Triplet loss). It will be appreciated that the style encoding loss function serves to constrain the 2-norm of the font style codes generated by different fonts to be as close to zero as possible. That is, the style encoding loss function may result in a 2-norm between two different font styles, the value of the 2-norm may be used to determine which font style the resulting font style is more biased towards; by keeping the value of the 2-norm as close to zero as possible, the resulting fused font style is between the two font styles and is not biased towards either one of the two font styles, in order to provide continuity in the fusion of different font styles. The style loss value is also used to correct the model parameters in a subsequent process so that the corrected model can output a character with a font style completely consistent with that of the character “ [symbol] ”.

In this embodiment, when the first loss value, the reconstruction loss, and the style loss value are obtained, the model parameters in the to-be-trained style feature fusion model may be corrected based on the first loss value, the reconstruction loss, and the style loss value. By taking a convergence of a loss function in the to-be-trained style feature fusion model as a training target, the target style feature fusion model can be obtained through training. It can be understood that the to-be-trained style feature fusion model has differences, in the training object and the corresponding loss function, from the above-mentioned to-be-trained stroke order determination model, while its training steps are similar to those of the to-be-trained stroke order determination model, which will not be repeated in the embodiments of the present disclosure.

It should also be noted that a style feature extraction sub-model, a stroke feature extraction sub-model, a content extraction sub-model, an encoding sub-model, and a compiler sub-model, which are described below in connection with FIG. 4, are included in the target style feature fusion model.

Referring to FIG. 4, block 1 shows a content extraction sub-model configured to extract content features of the to-be-processed character, wherein the content features include a character content and a to-be-processed character style; block 2 shows a stroke feature extraction sub-model configured to extract stroke features of the to-be-processed character. The style feature extraction sub-model (i.e., the font style extractor) can be input with a reference character “ [symbol] ” and a font style tag corresponding to the character “ [symbol] ”, so it can be understood that the style feature extraction sub-model is configured to extract the reference font style of the reference character image. The compiler sub-model is configured to perform an encoding process on the reference font style, the stroke features, and the content features to obtain the actually output character image; exemplarily, after extracting the character font style of the reference character, an encoding process may be performed on the extraction result based on the encoding sub-model, then the encoding result of the character font style of the reference character, and the extraction result of stroke order features of the to-be-processed character are collectively input into a compiler (Decoder) to obtain a character having a font style between the font style of the to-be-processed character and the font style of the reference character by the compiler. In addition, after the compiler, a stroke order predictor sub-model is connected and configured to predict the stroke order of the input character. For example, as shown in FIG. 2, the stroke order features corresponding to the character “ [symbol] ” are “left falling”, “right falling”, “horizontal turning and hook”, and “vertical curved hook”, respectively. After inputting the character “ [symbol] ” into the model, the stroke order features corresponding to the character “ [symbol] ” can be stored in a ht vector, and the vector ht={h1, h2, h3, and h4} can be obtained according to the stroke order. The resulting stroke order vector is then input into a stroke order prediction model, and the stroke order features are trained based on a neural network (e.g., a convolutional neural network), so that after the training of the to-be-trained style feature fusion model is completed, the stroke order features of each character can be predicted to avoid missing or incorrect stroke order in the output character results.

It should be noted that, before processing the character images by using the style feature extraction sub-model, the method further includes: obtaining a stroke feature extraction sub-model of the target style feature fusion model through training. Illustratively, during the training of the stroke feature extraction sub-model, a first set of training samples may be obtained; wherein the first set of training samples includes a plurality of training samples, and the training sample includes an image and a first stroke vector corresponding to a training character; for the plurality of training samples, the to-be-trained stroke feature extraction sub-model is trained by taking the image of the current training sample as an input parameter of the to-be-trained stroke feature extraction sub-model and taking the corresponding first stroke vector as an output parameter of the to-be-trained stroke feature extraction sub-model, so as to obtain the stroke feature extraction sub-model.

S240, generating a character package fused with at least two font styles based on the target style feature fusion model.

In this embodiment, after obtaining the target style feature fusion model, the model can be used to generate a character package in which at least two font styles are fused. The character package includes a plurality of to-be-used characters, and the to-be-used characters are generated based on the target style feature fusion model. For example, in order to obtain characters of two different font styles, images corresponding to the two characters may be processed separately based on the target style feature fusion model to obtain any one font style between the two font styles. If the font style obtained at this time is in accordance with the expectation of the user, the characters of the above two font styles may be processed based on the target font style fusion model to obtain the to-be-used character for each character in the corresponding style, and the set of all the to-be-used characters may be a character package.

It is to be noted that when a character package fused with at least two font styles is generated, the character package may be integrated into the relevant application program, for example, the generated character package is merged into a drop-down list of an editing bar of a text processing application. The drop-down list may have a presentation mode of a drop-down window containing various character styles or a picture presentation window, and the like. The user may click to select a target font style based on the option information in the list. When the client or server receives a relevant request from the user for selecting the target font style, the user may be provided with a source of the character package corresponding to the font style, thereby enabling the user to perform a character edition process by using the plurality of to-be-used characters therein.

Exemplarily, in a case that the user selects, in the drop-down list, the target font style as font C which is obtained by fusing font A and font B, upon receiving a to-be-processed character “ [symbol] ” as input, the server or the client may determine the character “ [symbol] ” from a character package corresponding to the target font style C and present it as the target character. It should be understood by those skilled in the art that the present technical solution can be applied in office software, that is, integrating the technical solution in the office software, or directly integrating the character package in the office software, or integrating the target style feature fusion model into a certain application software of the server or the client. Of course, in the actual application process, one or more of the above manners can be selected according to requirements to implement the technical solution of the present disclosure, which is not limited in the embodiments of the present disclosure.

In the present embodiment, when a target reference style character image and a target style conversion character image are received, at least one display character image may also be output based on a character content and a conversion character style of the target style conversion character image, as well as a reference character style of the target reference style character image, so as to determine a target display character image based on a triggering operation. The process of determining the target display character image is exemplarily described below with reference to FIG. 5.

Referring to FIG. 5, when the user expects to obtain at least ten styles of characters, target style feature fusion models for generating characters of ten styles may be integrated into a server or a client. After the target style feature fusion models, each corresponding to one of ten font styles, are integrated into a computationally efficient server or client, upon receiving a target reference style character image including a character “ [symbol] ” numbered 1 and a target style conversion character image including a character “ [symbol] ” numbered 10, the server or client integrated with the target style feature fusion models may be used to process the two images to determine the contents of the characters in the two images and the corresponding character styles, and then output display character images respectively containing the characters “ [symbol] ” numbered 2 to 9. As can be seen from FIG. 5, the font style of the finally resulting character “ [symbol] ” is between the font style of the character “ [symbol] ” numbered 1 and the font style of the character “ [symbol] ” numbered 10. It is to be understood that the font styles of the characters in these images are fused with two font styles. For example, if the character “ [symbol] ” numbered 5 and its font style both satisfy the user's expectations, the user may perform a triggering operation on the display character image (e.g., clicking on the image containing the character “ [symbol] ” numbered 5 on the touch screen), or may issue a confirmation instruction for the character “ [symbol] ” numbered 5 to the server or the client in various ways. When the server or the client detects the triggering operation or receives the confirmation instruction, the image containing the character “ [symbol] ” numbered 5 may be determined as a target display character image, and then a character package having a font style consistent with that of the target display character is constructed in accordance with the embodiments of the present disclosure, which will not be repeated here.

It is to be understood that models with different fusion ratios may be trained in advance and deployed on the mobile terminal or the server, so that when an initial input of the character image is detected, character styles of two character images may be fused based on the respective models, and the character images with different fusion ratios may be obtained and displayed. The user may trigger any one of the character images, and take the character image corresponding to the click confirmation as the target display character image. Meanwhile, a target model corresponding to the target display character image may be recorded, and a corresponding character package may be generated based on the target model, or character edition may be performed in real time. It is also possible to generate the character package based on the model for use in subsequent character edition.

Optionally, character edition is performed in real time or a character package corresponding to the target display character image is generated, based on the target style feature fusion model corresponding to the target display character image. When the server or client determines the target style feature fusion model corresponding to the target display character image based on the user's selection, the model may be used by the server or client at the current node. On this basis, when the server or the client receives text information input by the user, the model can be used to convert each of at least one character in the text information to have the font style of the character in the target display character image, and the converted character is displayed on the corresponding display interface, thereby implementing a real-time processing function on the font style of the character. For example, when an image containing the character “ [symbol] ” numbered 5 is used as the target display character image by the user, it can be determined that the model for generating the image is the target style feature fusion model used in the current stage. Based on this, when the user inputs arbitrary Chinese characters in real time, either the server or the client can generate Chinese characters with a font style and a fusion ratio corresponding to those of the character “ [symbol] ” numbered 5 by using the target style feature fusion model.

Alternatively, when the server or the client determines the target style feature fusion model corresponding to the target display character image based on the user's selection, the fonts of all the characters in a character library according to the related art may be directly converted by using the model; and after a plurality of characters corresponding to the font style of the character in the target display character image are obtained, a new character package may be constructed based on these characters, and the character package may be integrated into the system or the corresponding application software for the user to use. Of course, in the actual application process, after the target style feature fusion model is determined, it is possible to select, among the above two processing manners, according to actual requirements, which is not limited in the embodiments of the present disclosure.

It should be noted that if the character style of the target display character is not consistent with the expected character style, the target reference style character image and/or the target style conversion character image is/are updated according to the expected character style, which will be described with continued reference to FIG. 5.

With continued reference to FIG. 5, if the character “ [symbol] ” numbered 5 and its font style are not in accordance with the user's expectation, and the character “ [symbol] ” numbered 4 and its font style are what the user finally wants to obtain, the server or the client may continue to use the target style feature fusion model to process the above-mentioned two images by using the image containing the character “ [symbol] ” numbered 1 as the target reference style character image and using the image containing the character “ [symbol] ” numbered 5 as the target style conversion character image, in the manner described above, thereby obtaining the image containing the character “ [symbol] ” numbered 3; furthermore, the server or the client may continue to determine whether the font style of the character in the image is in accordance with the user's expectation according to the user's triggering operation.

According to the technical solution of the present embodiment, the target stroke order determination model is used as a loss function of the to-be-trained style feature fusion model, so as to obtain the target style feature fusion model by training, which enables the user to use the model to fuse the font style of the to-be-processed character and the font style of the reference character to obtain any one of the font styles between the font style of the to-be-processed character and the font style of the reference character, and solves the problem that a character having a font style between the two font styles cannot be generated; meanwhile, the style feature fusion model is constructed based on a plurality of sub-models, which solves the problem that the font style of the target character is not identical to the character style desired by the user.

FIG. 6 is a schematic structural diagram of a character processing apparatus according to an embodiment of the present disclosure. As shown in FIG. 6, the apparatus includes a first image acquisition module 310, a stroke order determination model training module 320, and a target stroke order determination module 330.

The first image acquisition module 310 is configured to acquire a first image including a to-be-processed character.

The stroke order determination model training module 320 is configured to train a target stroke order determination model by combining with a spatial attention mechanism and a channel attention mechanism.

The target stroke order determination module 330 is configured to input the first image into the target stroke order determination model trained in advance to obtain a target stroke order corresponding to the to-be-processed character.

Based on the above technical solutions, the character processing apparatus further includes a first training sample acquiring module, a predicted stroke order determining module, a correcting module, and a target stroke order determination model determining module.

The first training sample acquiring module is configured to acquire at least one first training sample; wherein the first training sample includes a sample character image and a theoretical character stroke order to which the sample character image corresponds.

The predicted stroke order determining module is configured to input, for the at least one first training sample, a sample character image from a current first training sample into a to-be-trained stroke order determination model to obtain a predicted stroke order.

The correcting module is configured to determine a loss value based on the predicted stroke order and the theoretical character stroke order in the current first training sample, and to correct model parameters of the to-be-trained stroke order determination model based on the loss value.

The target stroke order determination model determining module is configured to obtain the target stroke order determination model by taking a convergence of a loss function in the to-be-trained stroke order determination model as a training target.

Optionally, the predicted stroke order determining module is further configured to input the sample character image into a convolutional layer to obtain a first to-be-processed feature; performing feature extraction on the first to-be-processed feature by the channel attention mechanism and the spatial attention mechanism to obtain a second to-be-processed feature; inputting the second to-be-processed feature into a recurrent neural network unit, and acquiring a feature sequence corresponding to a position and an order of each stroke; and processing each feature sequence based on a classifier to obtain a predicted stroke order.

On the basis of the above technical solutions, the character processing apparatus further includes a loss model determination module.

The loss model determination module is configured to obtain the target style feature fusion model by training a to-be-trained style feature fusion model, with the target stroke order determination model used as a loss model of the to-be-trained style feature fusion model; wherein the target style feature fusion model is configured to fuse at least two font styles.

Optionally, the loss model determination module is further configured to determine at least one second training sample, wherein the second training sample includes a to-be-trained character image and a reference character image; for the at least one second training sample, input the to-be-trained character image and the reference character image in the current training sample into the to-be-trained style feature fusion model to obtain an actually output character image corresponding to the to-be-trained character image; performing stroke loss processing on the actually output character image and the to-be-trained character image based on the target stroke order determination model to obtain a first loss value; determine a reconstruction loss for the actually output character image and the to-be-trained character image based on a reconstruction loss function; determine a style loss value for the actually output character image and a fused character image based on a style encoding loss function, wherein the fused character image is determined based on the font styles of the to-be-trained character image and the reference character image; correct model parameters in the to-be-trained style feature fusion model based on the first loss value, the reconstruction loss, and the style loss value; and obtain a target style feature fusion model through training by taking a convergence of a loss function in the to-be-trained style feature fusion model as a training target.

On the basis of the above technical solutions, the target style feature fusion model includes a style feature extraction sub-model, a stroke feature extraction sub-model, a content extraction sub-model, and a compiler sub-model; wherein the style feature extraction sub-model is configured to extract a reference font style of the reference character image; the stroke feature extraction sub-model is configured to extract a stroke feature of the to-be-processed character; the content extraction sub-model is configured to extract a content feature of the to-be-processed character, wherein the content feature includes a character content and a to-be-processed character style; the compiler sub-model is configured to encode the reference font style, the stroke feature and the content feature to obtain an actually output character image.

On the basis of the above technical solutions, the character processing apparatus further includes a character package generating module.

The character package generating module is configured to generate a character package fused with at least two font styles based on the target style feature fusion model.

On the basis of the above technical solutions, the character processing apparatus further includes an image receiving module and a display character image determining module.

The image receiving module is configured to receive a target reference style character image and a target style conversion character image.

The display character image determining module is configured to output at least one display character image based on a character content and a conversion character style of the target style conversion character image, as well as a reference character style of the target reference style character image, so as to determine a target display character image based on a triggering operation.

On the basis of the above technical solutions, the character processing apparatus further includes a character processing module.

The character processing module is configured to perform character edition in real time or generate a character package corresponding to the target display character image based on the target style feature fusion model corresponding to the target display character image.

On the basis of the above technical solutions, the character processing apparatus further includes an image update module.

The image update module is configured to update the target reference style character image and/or the target style conversion character image according to an expected character style if the character style of the target display character is not consistent with the expected character style.

The technical solution provided by the present embodiment includes: acquiring a first image including a to-be-processed character firstly, and then inputting the first image into a target stroke order determination model trained in advance including a spatial attention mechanism and a channel attention mechanism, thereby obtaining a target stroke order corresponding to the to-be-processed character. By introducing the above-mentioned two mechanisms into the stroke order determination model, the position and order of each stroke of the character can be accurately obtained, thereby greatly reducing the occurrence of stroke breakage, stroke edge irregularity, stroke loss or stroke redundancy in the generated character and improving the accuracy rate of the generated character.

The character processing apparatus provided by the embodiments of the present disclosure may perform the character processing method provided by any of the embodiments of the present disclosure, and may include corresponding functional modules for performing the method.

It should be noted that the respective units and modules included in the above apparatus are divided only according to functional logic, but are not limited to the above division as long as the corresponding functions can be realized. In addition, the specific names of the respective functional units are also merely for convenience of distinguishing them from each other, and are not used to limit the scope of protection of the embodiments of the present disclosure.

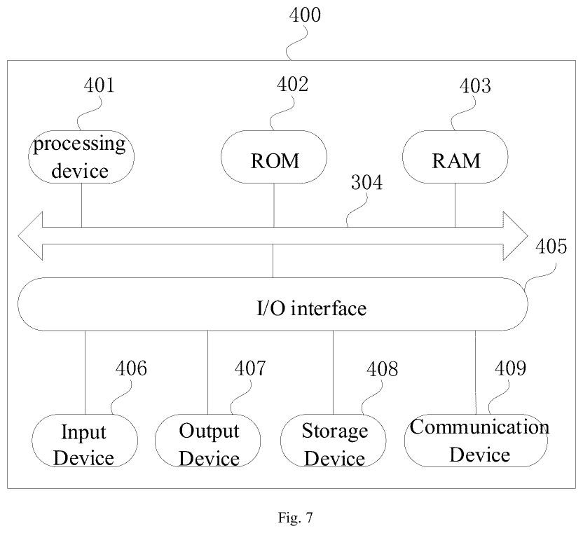

FIG. 7 is a schematic structural diagram of an electronic device according to an embodiment of the present disclosure. Reference is now made to FIG. 7, which shows a schematic structural diagram of an electronic device (e.g., a terminal device or server in FIG. 7) 400 suitable for use in implementing embodiments of the present disclosure. The terminal device in the embodiment of the present disclosure may include, but is not limited to, a mobile terminal such as a mobile phone, a notebook computer, a digital broadcast receiver, a personal digital assistant (PDA), a tablet computer (PAD), a portable media player (PMP), a vehicle-mounted terminal (e.g., a vehicle-mounted navigation terminal), etc., and a fixed terminal such as a digital television (TV), a desktop computer, etc. The electronic device illustrated in FIG. 7 is merely an example and should not bring any limitation to the scope of functionality and use of embodiments of the present disclosure.

As shown in FIG. 7, the electronic device 400 may include a processing device (e.g., a central processor, a pattern processor, etc.) 401 that may execute various appropriate actions and processes according to a program stored in a read-only memory (ROM) 402 or a program loaded into a random-access memory (RAM) 403 from a storage device 406. In the RAM 403, various programs and data required for the operation of the electronic device 400 are also stored. The processing device 401, the ROM 402 and the RAM 403 are connected to each other by a bus 404. An input/output (I/O) interface 405 is also connected to the bus 404.

In general, the following devices may be connected to the I/O interface 405: an editing device 406 including, for example, a touch screen, a touch pad, a keyboard, a mouse, a camera, a microphone, an accelerometer, a gyroscope, etc.; an output device 407 including, for example, a liquid crystal display (LCD), a speaker, a vibrator, etc.; a storage device 408 including, for example, a magnetic tape, a hard disk, etc.; and a communication device 409. The communication device 409 may allow the electronic device 400 to have wireless or wired communication with other devices to exchange data. Although FIG. 7 illustrates an electronic device 400 provided with various devices, it is to be understood that it is not required of implementation or availability of all the illustrated devices. More or fewer devices may alternatively be implemented or provided.

In particular, according to an embodiment of the present disclosure, the processes described above with reference to the flowcharts may be implemented as a computer software program. For example, embodiments of the present disclosure include a computer program product including a computer program carried on a non-transitory computer-readable medium, the computer program containing program codes for performing the methods illustrated by the flowcharts. In such an embodiment, the computer program may be downloaded and installed from the network via the communications device 409, or installed from the storage device 406, or installed from the ROM 402. When this computer program is executed by the processing device 401, the above-described functions defined in the method of the embodiments of the present disclosure are performed.

The names of messages or information interacted between devices in an implementation of the present disclosure are for illustrative purposes only and are not intended to limit the scope of such messages or information.

The electronic device provided by the embodiments of the present disclosure belongs to the same inventive concept as the character processing method provided by the above embodiments, for technical details that are not elaborately described in the present embodiment, reference can be made to the above embodiments.

An embodiment of the present disclosure provides a computer storage medium having a computer program stored thereon, wherein the computer program, when executed by a processor, implements the character processing method provided by the above embodiments.

It should be noted that the above-described computer-readable medium of the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any computer-readable medium other than the computer-readable storage medium. The computer-readable signal medium may send, propagate or transmit a program used by or in combination with an instruction execution system, apparatus, or device. The program code contained on the computer-readable medium may be transmitted by using any suitable medium, including but not limited to an electric wire, a fiber-optic cable, radio frequency (RF) and the like, or any appropriate combination of them.

In some embodiments, the client and the server may perform communication by using any network protocol currently known or to be researched and developed in the future such as hypertext transfer protocol (HTTP), and may be interconnected with any digital data communication (e.g., communication network) in any form or medium. Examples of communication networks include a local area network (LAN), a wide area network (WAN), the Internet, and a peer-to-peer network (e.g., an ad hoc peer-to-peer network), as well as any network currently known or to be researched and developed in the future.

The above-mentioned computer-readable medium may be included in the above-mentioned electronic device; it may also be present separately and not incorporated into the electronic device.

The computer-readable medium carries at least one program that, when executed by the electronic device, causes the electronic device to:
acquire a first image including a to-be-processed character;
train a target stroke order determination model by combining with a spatial attention mechanism and a channel attention mechanism; and
input the first image into the target stroke order determination model trained in advance to obtain
a target stroke order corresponding to the to-be-processed character.

Computer program codes for performing the operations of the present disclosure may be written in one or more programming languages or a combination thereof, including but not limited to object-oriented programming languages such as Java, Smalltalk, C++, and conventional procedural programming languages such as “C” or similar programming languages. The program codes may be executed entirely on the user's computer, partly on the user's computer, as a stand-alone software package, partly on the user's computer and partly on a remote computer, or entirely on a remote computer or server. In situations involving remote computers, the remote computer can be connected to the user's computer through any kind of network, including a local area network (LAN) or a wide area network (WAN), or it can be connected to an external computer (e.g., through Internet connection by an Internet service provider).

The flowcharts and block diagrams in the figures illustrate the architecture, functionality, and operations of possible implementations of systems, methods, and computer program products according to various embodiments of the present disclosure. In this regard, each block in the flowcharts or block diagrams may represent a module, a program segment, or a portion of codes which contain one or more executable instructions for implementing specified logic functions. It is also to be noted that, in some alternative implementations, the functions labeled in the block may be performed in a sequence different from those labeled in the figures. For example, two blocks shown one after another may actually be executed substantially in parallel, or they may sometimes be executed in a reverse order, depending on the functionality involved. It will also be noted that each block of the block diagram and/or flowchart, and combinations of blocks in the block diagram and/or flowchart illustration, can be implemented by special purpose hardware-based systems that perform the specified functions or operations, or can be implemented by using a combination of specialized hardware and computer instructions.

The units described in the embodiments of the present disclosure may be implemented by means of software or by means of hardware. The name of the unit/module does not constitute a limitation on the unit itself under certain circumstances, for example, the first acquisition unit may also be described as “a unit for acquiring at least two Internet protocol addresses”.

The functionality described above in the present disclosure can be performed, at least in part, by one or more hardware logic components. For example, and without limited, illustrative types of hardware logic components that can be used include field-programmable gate arrays (FPGAs), application specific integrated circuits (ASICs), application specific standard parts (ASSPs), system on chip (SOCs), complex programmable logic devices (CPLDs), etc.

In the context of the present disclosure, a machine-readable medium may be a tangible medium that may contain or store a program for use by or in connection with an instruction execution system, apparatus, or device. The machine-readable medium may be a machine-readable signal medium or a machine-readable storage medium. Machine-readable medium may include, but not limited to, electronic, magnetic, optical, electromagnetic, infrared, or semiconductor systems, apparatuses or devices, or any suitable combination of the foregoing. More specific examples of machine-readable storage medium may include one or more wire-based electrical connections, laptop disks, hard drives, random access memory (RAM), read only memory (ROM), erasable programmable read only memory (EPROM or flash memory), optical fiber, portable compact disk read-only memory (CD-ROM), optical storage device, magnetic storage device, or any suitable combination of the above.

In accordance with at least one embodiment of the present disclosure, there is provided a character processing method in [Example One], the method includes:
acquiring a first image including a to-be-processed character;
training a target stroke order determination model by combining with a spatial attention mechanism and a channel attention mechanism; and
inputting the first image into the target stroke order determination model trained in advance to obtain a target stroke order corresponding to the to-be-processed character.

In accordance with at least one embodiment of the present disclosure, there is provided a character processing method in [Example Two], the method further includes:
optionally, acquiring at least one first training sample; wherein the first training sample includes a sample character image and a theoretical character stroke order to which the sample character image corresponds;
for the at least one first training sample, inputting the sample character image of a current first training sample into a to-be-trained stroke order determination model to obtain a predicted stroke order;
determining a loss value based on the predicted stroke order and the theoretical character stroke order in the current first training sample, and correcting a model parameter for the to-be-trained stroke order determination model based on the loss value; and
taking a convergence of a loss function in the to-be-trained stroke order determination model as a training target to obtain the target stroke order determination model.

In accordance with at least one embodiment of the present disclosure, there is provided a character processing method in [Example Three], the method further includes:
optionally, inputting the sample character image into a convolutional layer to obtain a first to-be-processed feature;
performing a feature extraction on the first to-be-processed feature by the channel attention mechanism and the spatial attention mechanism to obtain a second to-be-processed feature;
inputting the second to-be-processed feature into a recurrent neural network unit to obtain a feature sequence corresponding to a position and an order of each stroke; and
processing the feature sequence based on a classifier to obtain the predicted stroke order.

In accordance with at least one embodiment of the present disclosure, there is provided a character processing method in [Example Four], the method further includes:
optionally, obtaining a target style feature fusion model by training a to-be-trained style feature fusion model, with the target stroke order determination model used as a loss model of the to-be-trained style feature fusion model;
wherein the target style feature fusion model is configured to fuse at least two font styles.

In accordance with at least one embodiment of the present disclosure, there is provided a character processing method in [Example Five], the method further includes:
optionally, determining at least one second training sample; wherein the second training sample includes a to-be-trained character image and a reference character image;
for the at least one second training sample, inputting the to-be-trained character image and the reference character image of a current training sample into the to-be-trained style feature fusion model to obtain an actually output character image corresponding to the to-be-trained character image;
performing stroke loss processing on the actually output character image and the to-be-trained character image based on the target stroke order determination model to obtain a first loss value;
determining, for the actually output character image and the to-be-trained character image, a reconstruction loss based on a reconstruction loss function;
determining, for the actually output character image and a fused character image, a style loss value based on a style encoding loss function; wherein the fused character image is determined based on a font style of the to-be-trained character image and a font style of the reference character image;
correcting a model parameter in the to-be-trained style feature fusion model based on the first loss value, the reconstruction loss, and the style loss value; and
obtaining the target style feature fusion model by training the to-be-trained style feature fusion model with a convergence of a loss function in the to-be-trained style feature fusion model as a training target.

In accordance with at least one embodiment of the present disclosure, there is provided a character processing method in [Example Six], the method further includes:
optionally, the target style feature fusion model includes a style feature extraction sub-model, a stroke feature extraction sub-model, a content extraction sub-model, and a compiler sub-model;
wherein the style feature extraction sub-model is configured to extract a reference font style of the reference character image;
the stroke feature extraction sub-model is configured to extract a stroke feature of the to-be-processed character;
the content extraction sub-model is configured to extract a content feature of the to-be-processed character; wherein the content feature includes a character content and a to-be-processed character style;
and
the compiler sub-model is configured to encode the reference font style, the stroke feature and the content feature to obtain an actually output character image.

In accordance with at least one embodiment of the present disclosure, there is provided a character processing method in [Example Seven], the method further includes:
optionally, receiving a target reference style character image and a target style conversion character image; and
outputting at least one display character image based on a character content and a conversion character style of the target style conversion character image, as well as a reference character style of the target reference style character image to determine a target display character image based on a triggering operation.

In accordance with at least one embodiment of the present disclosure, there is provided a character processing method in [Example Eight], the method further includes:
optionally, performing character edition in real time or generating a character package corresponding to the target display character image, based on the target style feature fusion model corresponding to the target display character image.

In accordance with at least one embodiment of the present disclosure, there is provided a character processing apparatus in [Example Nine], the apparatus includes:
a first image acquisition module, configured to acquire a first image comprising a to-be-processed character;
a stroke order determination model training module, configured to train a target stroke order determination model by combining with a spatial attention mechanism and a channel attention mechanism; and
a target stroke order determination module, configured to input the first image into the target stroke order determination model trained in advance to obtain a target stroke order corresponding to the to-be-processed character.

Furthermore, although various operations are depicted in a specific order, this should not be understood as requiring that these operations be performed in the specific order as shown or performed in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Vice versa, various features that are described in the context of a single embodiment can also be implemented in multiple embodiments separately or in any suitable sub-combination.

1. A character processing method, comprising:
acquiring a first image comprising a to-be-processed character;
training a target stroke order determination model by combining with a spatial attention mechanism and a channel attention mechanism; and
inputting the first image into the target stroke order determination model trained in advance to obtain a target stroke order corresponding to the to-be-processed character.

2. The method according to claim 1, further comprising:
acquiring at least one first training sample; wherein the first training sample comprises a sample character image and a theoretical character stroke order to which the sample character image corresponds;
inputting, for the at least one first training sample, the sample character image of a current first training sample into a to-be-trained stroke order determination model to obtain a predicted stroke order;
determining a loss value based on the predicted stroke order and the theoretical character stroke order in the current first training sample, and correcting a model parameter for the to-be-trained stroke order determination model based on the loss value; and
obtaining the target stroke order determination model by taking a convergence of a loss function in the to-be-trained stroke order determination model as a training target.

3. The method according to claim 2, wherein the inputting the sample character image of a current first training sample into a to-be-trained stroke order determination model to obtain a predicted stroke order, comprises:
inputting the sample character image into a convolutional layer to obtain a first to-be-processed feature;
performing a feature extraction on the first to-be-processed feature by the channel attention mechanism and the spatial attention mechanism to obtain a second to-be-processed feature;
inputting the second to-be-processed feature into a recurrent neural network unit to obtain a feature sequence corresponding to a position and an order of each stroke; and
processing the feature sequence based on a classifier to obtain the predicted stroke order.

4. The method according to claim 1, further comprising:
obtaining a target style feature fusion model by training a to-be-trained style feature fusion model, with the target stroke order determination model used as a loss model of the to-be-trained style feature fusion model;
wherein the target style feature fusion model is configured to fuse at least two font styles.

5. The method according to claim 4, wherein the obtaining a target style feature fusion model by training a to-be-trained style feature fusion model comprises:
determining at least one second training sample; wherein the second training sample comprises a to-be-trained character image and a reference character image;
inputting, for the at least one second training sample, the to-be-trained character image and the reference character image of a current second training sample into the to-be-trained style feature fusion model to obtain an actually output character image corresponding to the to-be-trained character image;
performing stroke loss processing on the actually output character image and the to-be-trained character image based on the target stroke order determination model to obtain a first loss value;
determining, for the actually output character image and the to-be-trained character image, a reconstruction loss based on a reconstruction loss function;
determining, for the actually output character image and a fused character image, a style loss value based on a style encoding loss function; wherein the fused character image is determined based on a font style of the to-be-trained character image and a font style of the reference character image;
correcting a model parameter in the to-be-trained style feature fusion model based on the first loss value, the reconstruction loss, and the style loss value; and
obtaining the target style feature fusion model by training the to-be-trained style feature fusion model, with a convergence of a loss function in the to-be-trained style feature fusion model used as a training target.

6. The method according to claim 5, wherein the target style feature fusion model comprises a style feature extraction sub-model, a stroke feature extraction sub-model, a content extraction sub-model, and a compiler sub-model; wherein
the style feature extraction sub-model is configured to extract a reference font style of the reference character image;
the stroke feature extraction sub-model is configured to extract a stroke feature of the to-be-processed character;
the content extraction sub-model is configured to extract a content feature of the to-be-processed character; wherein the content feature comprises a character content and a to-be-processed character style; and
the compiler sub-model is configured to encode the reference font style, the stroke feature and the content feature to obtain the actually output character image.

7. The method according to claim 4, further comprising:
receiving a target reference style character image and a target style conversion character image; and
outputting at least one display character image based on a character content and a conversion character style of the target style conversion character image, as well as a reference character style of the target reference style character image to determine a target display character image based on a triggering operation.

8. The method according to claim 7, further comprising:
performing character edition in real time or generating a character package corresponding to the target display character image, based on the target style feature fusion model corresponding to the target display character image.

9. (canceled)

10. An electronic device, comprising:
at least one processor; and
a storage device configured to store at least one program, wherein
the at least one program, when executed by the at least one processor, is configured to cause the at least one processor to implement a character processing method, comprising:
acquiring a first image comprising a to-be-processed character;
training a target stroke order determination model by combining with a spatial attention mechanism and a channel attention mechanism; and
inputting the first image into the target stroke order determination model trained in advance to obtain a target stroke order corresponding to the to-be-processed character.

11. A non-transient storage medium comprising computer-executable instructions, wherein the computer-executable instructions, when executed by a computer processor, are configured to implement a character processing method, comprising:
acquiring a first image comprising a to-be-processed character;
training a target stroke order determination model by combining with a spatial attention mechanism and a channel attention mechanism; and
inputting the first image into the target stroke order determination model trained in advance to obtain a target stroke order corresponding to the to-be-processed character.

12. The electronic device according to claim 10, wherein the character processing method further comprises:
acquiring at least one first training sample; wherein the first training sample comprises a sample character image and a theoretical character stroke order to which the sample character image corresponds;
inputting, for the at least one first training sample, the sample character image of a current first training sample into a to-be-trained stroke order determination model to obtain a predicted stroke order;
determining a loss value based on the predicted stroke order and the theoretical character stroke order in the current first training sample, and correcting a model parameter for the to-be-trained stroke order determination model based on the loss value; and
obtaining the target stroke order determination model by taking a convergence of a loss function in the to-be-trained stroke order determination model as a training target.

13. The electronic device according to claim 12, wherein in the character processing method,
the inputting the sample character image of a current first training sample into a to-be-trained stroke order determination model to obtain a predicted stroke order, comprises:
inputting the sample character image into a convolutional layer to obtain a first to-be-processed feature;
performing a feature extraction on the first to-be-processed feature by the channel attention mechanism and the spatial attention mechanism to obtain a second to-be-processed feature;
inputting the second to-be-processed feature into a recurrent neural network unit to obtain a feature sequence corresponding to a position and an order of each stroke; and
processing the feature sequence based on a classifier to obtain the predicted stroke order.

14. The electronic device according to claim 10, wherein the character processing method further comprises:
obtaining a target style feature fusion model by training a to-be-trained style feature fusion model, with the target stroke order determination model used as a loss model of the to-be-trained style feature fusion model;
wherein the target style feature fusion model is configured to fuse at least two font styles.

15. The electronic device according to claim 14, wherein in the character processing method, the obtaining a target style feature fusion model by training a to-be-trained style feature fusion model comprises:
determining at least one second training sample; wherein the second training sample comprises a to-be-trained character image and a reference character image;
inputting, for the at least one second training sample, the to-be-trained character image and the reference character image of a current second training sample into the to-be-trained style feature fusion model to obtain an actually output character image corresponding to the to-be-trained character image;
performing stroke loss processing on the actually output character image and the to-be-trained character image based on the target stroke order determination model to obtain a first loss value;
determining, for the actually output character image and the to-be-trained character image, a reconstruction loss based on a reconstruction loss function;
determining, for the actually output character image and a fused character image, a style loss value based on a style encoding loss function; wherein the fused character image is determined based on a font style of the to-be-trained character image and a font style of the reference character image;
correcting a model parameter in the to-be-trained style feature fusion model based on the first loss value, the reconstruction loss, and the style loss value; and
obtaining the target style feature fusion model by training the to-be-trained style feature fusion model, with a convergence of a loss function in the to-be-trained style feature fusion model used as a training target.

16. The electronic device according to claim 15, wherein in the character processing method, the target style feature fusion model comprises a style feature extraction sub-model, a stroke feature extraction sub-model, a content extraction sub-model, and a compiler sub-model; wherein
the style feature extraction sub-model is configured to extract a reference font style of the reference character image;
the stroke feature extraction sub-model is configured to extract a stroke feature of the to-be-processed character;
the content extraction sub-model is configured to extract a content feature of the to-be-processed character; wherein the content feature comprises a character content and a to-be-processed character style; and
the compiler sub-model is configured to encode the reference font style, the stroke feature and the content feature to obtain the actually output character image.

17. The electronic device according to claim 14, wherein the character processing method further comprises:
receiving a target reference style character image and a target style conversion character image; and
outputting at least one display character image based on a character content and a conversion character style of the target style conversion character image, as well as a reference character style of the target reference style character image to determine a target display character image based on a triggering operation.

18. The electronic device according to claim 17, wherein the character processing method further comprises:
performing character edition in real time or generating a character package corresponding to the target display character image, based on the target style feature fusion model corresponding to the target display character image.

19. The non-transient storage medium according to claim 11, wherein the character processing method further comprises:
acquiring at least one first training sample; wherein the first training sample comprises a sample character image and a theoretical character stroke order to which the sample character image corresponds;
inputting, for the at least one first training sample, the sample character image of a current first training sample into a to-be-trained stroke order determination model to obtain a predicted stroke order;
determining a loss value based on the predicted stroke order and the theoretical character stroke order in the current first training sample, and correcting a model parameter for the to-be-trained stroke order determination model based on the loss value; and
obtaining the target stroke order determination model by taking a convergence of a loss function in the to-be-trained stroke order determination model as a training target.

20. The non-transient storage medium according to claim 19, wherein in the character processing method,
the inputting the sample character image of a current first training sample into a to-be-trained stroke order determination model to obtain a predicted stroke order, comprises:
inputting the sample character image into a convolutional layer to obtain a first to-be-processed feature;
performing a feature extraction on the first to-be-processed feature by the channel attention mechanism and the spatial attention mechanism to obtain a second to-be-processed feature;
inputting the second to-be-processed feature into a recurrent neural network unit to obtain a feature sequence corresponding to a position and an order of each stroke; and
processing the feature sequence based on a classifier to obtain the predicted stroke order.

21. The non-transient storage medium according to claim 11, wherein the character processing method further comprises:
obtaining a target style feature fusion model by training a to-be-trained style feature fusion model, with the target stroke order determination model used as a loss model of the to-be-trained style feature fusion model;
wherein the target style feature fusion model is configured to fuse at least two font styles.
